(19) United States
(12) Patent Application Publication
(10) Pub. No.: US 2026/0070817 A1
(43) Pub. Date: Mar. 12, 2026

(54) Electrochemical Method of Creating an Enduring Chain Reaction in an Aqueous Solution

(71) Applicants: Andrew Macdonald-Hardie, McMurray, PA (US); Ryan Myers, McMurray, PA (US); Yanbo Li, Xianghe (CN)

(72) Inventors: Andrew Macdonald-Hardie, McMurray, PA (US); Ryan Myers, McMurray, PA (US); Yanbo Li, Xianghe (CN)

(21) Appl. No.: 19/328,669

(22) Filed: Sep. 15, 2025

Related U.S. Application Data
(63) Continuation-in-part of application No. 18/361,785, filed on Jul. 28, 2023.

(51) Int. Cl. C02F 1/461; C02F 101/36; C25B 3/20; C25B 11/043

(52) U.S. Cl. CPC C02F 1/46109; C25B 3/20; C25B 11/043; C02F 2001/46133; C02F 2101/36; C02F 2201/4614; C02F 2201/4617

(57) ABSTRACT

The invention is directed to a method of generating at least one long half-life free radical by an electrochemical cell, said apparatus having suitable electrode plates, which comprises the following steps: passing an aqueous solution containing unwanted contaminants through at least one pair of electrodes to which a DC electrical current is passed in such a fashion that at least one long half-life free radical is created which initiates an enduring, i.e. continuing, chain reaction which will consume, remove, or destroy any available contaminants, wherein the DC electrical current is controlled so as cause the potential difference across the electrochemical cell to be at a controlled rate to achieve a precise value within a specified time.

### CROSS REFERENCE TO RELATED APPLICATIONS

This application is a continuation-in-part of U.S. patent application Ser. No. 18/361,785, filed Jul. 28, 2023, which is incorporated herein by reference in its entirety.

### TECHNICAL FIELD

The present invention relates to an electrochemical method of initiating an enduring chain reaction in aqueous solution which can be caused to propagate in a water volume without outside influence so as to remove various solutes from the water volume. The invention can be used in a number of technical fields, including, without limitation, (1) removal of PFAS (per-and polyfluoro alkyl substances) from the environment; (2) carbon dioxide capture and removal from the atmosphere; (3) Nutrient removal from the environment; (4) wastewater treatment; (5) drinking water treatment; (6) organic chemical manufacture; (7) removing perchlorates from the environment; and (8) and most likely other technical fields which are as yet unidentified.

### BACKGROUND OF THE INVENTION

Water is a universal and very effective solvent. In the technical fields referred to above, at some point there is a necessity to remove contaminants or pollutants in aqueous solution so as to reduce their concentration in said aqueous solution. There are many existing processes that can be and are used to achieve this. They include biological processes, physicochemical processes, incineration processes, thermal processes, advanced oxidation processes, and several electrochemical processes. All of these currently available, prior art processes have some if not all of the following disadvantages and shortcomings: (1) they have limited efficacy and only partially remove contaminants present in aqueous solution; (2) they have very high capital cost; (3) they use much energy resulting in high operating costs; (4) they consume a lot of chemicals which further adds to high operating costs; (5) the processes themselves cause further adverse environmental issues; and (6) they are difficult to control.

As a consequence, the challenges to the environment from the pollutants and contaminants associated with the referenced fields have not been adequately resolved. One process that has been considered to address these challenges is electrochemical oxidation, specifically using boron doped diamond (BDD) electrodes. When an electric current is passed through an electrochemical cell containing BDD electrodes, electrochemical oxidation has been shown to reduce the concentration of PFAS dissolved in the aqueous electrolyte, reduce dissolved carbon dioxide, and destroy organic pollutants at high, almost 100%, current efficiency. Electrochemical oxidation, however, displays significant shortcomings and deficiencies. Such shortcomings and deficiencies of electrochemical oxidation include but are not limited to:
(1) When used to remediate water contaminated with PFAS, the process only achieves partial destruction of certain PFAS, creates byproduct short chain PFAS, and generates hazardous perchlorates during the reaction. In addition, the rate of reaction is very slow resulting in continuous high energy consumption.
(2) The process has been shown to reduce dissolved carbon dioxide to carbon monoxide but the rate of reaction is very slow and the continuous supply of energy to the electrochemical cell is very high. As a result, the process is not economically viable for carbon dioxide reduction. In addition, hazardous perchlorate is created as a byproduct.
(3) When used to destroy organic materials dissolved in wastewater, the rate of reaction is slow, resulting in high energy costs, incomplete reactions occur resulting in undesirable byproducts, perchlorates are generated, and process efficacy varies dependent on the pollutants present in the wastewater.
(4) In all of its applications, the mass of pollutant or contaminant removed by electrochemical oxidation is directly proportional to the area of electrode installed. Boron doped diamond electrodes are expensive and so the capital cost of the process is very high.
(5) The mass of contaminant removed is directly proportional to the energy applied resulting in high energy consumption.

Clearly, electrochemical oxidation is not a viable solution to the challenges to the environment in the referenced fields. There is a continuing and, indeed, an urgent need for an effective and economic means of addressing the environmental issues described here as well as many others. A simple, cost effective, high performance process would be impactful in addressing the environmental pressures that confront us today.

### SUMMARY OF THE INVENTION

The present invention more than fulfills this need by providing a unique method for the removal or destruction of unwanted contaminants in aqueous solution which comprises electrochemical initiation of an enduring, i.e., continuing, chain reaction in aqueous solution which proceeds with minimum outside influence to consume unwanted contaminants.

In particular, the benefits and advantages of the inventive method can be summarized as follows: (1) it non-selectively removes or destroys all organic and targeted inorganic pollutants in aqueous solution at very low cost; (2) it removes or destroys all PFAS to very low concentrations; (3) it reduces carbon dioxide dissolved in water at low cost; (4) it removes or destroys ammoniacal nitrogen and nitrates dissolved in water at low cost; (5) it removes inorganic and organic phosphates from aqueous solution; (6) it removes or destroys a number of inorganic compounds dissolved in any water, including without limitation, sulfides and perchlorates; (7) it generates at least one long half-life free radical at low temperature and pressure which can be utilized in other processes that require the generation of free radicals; (8) once initiated, the chain reaction is not affected by the nature of the analysis of the aqueous solution; (9) once initiated, the chain reaction needs no substantial further energy input and progresses to termination without outside influence; and (10) it has a low cost of ownership.

The important objectives, features, and additional advantages of the invention will become apparent to those skilled in the art from the foregoing, and from the detailed description which follows, and from the appended claims, in conjunction with the accompanying drawings.

### BRIEF DESCRIPTION OF DRAWINGS

In order to attain a more complete appreciation of the invention and of the novel features and the advantages thereof, attention is directed to the following detailed description when considered in connection with the accompanying figures, wherein:

FIG. 1 illustrates a generalized process flow diagram for a system employing the inventive method in a variety of applications and with a variety of feedwaters;

FIG. 2 illustrates how power is applied in the method of the invention;

FIG. 3 illustrates a process flow diagram of the laboratory set-up in which an aqueous solution is provided as a once-only addition to the feed tank, in accordance with a method of the invention; and

FIG. 4 illustrates a process flow diagram of the laboratory set-up in which an aqueous solution is provided to the feed tank continuously, in accordance with a method of the invention.

The foregoing figures, being merely exemplary, contain various steps which may be present or omitted from actual implementations depending upon the circumstances.

An attempt has been made to draw the figures in a way that illustrates at least those elements that are significant for an understanding of the various embodiments and aspects of the invention. However, various other method steps may be utilized in order to provide a complete treatment system for use in a particular set of circumstances.

### DETAILED DESCRIPTION OF THE INVENTION

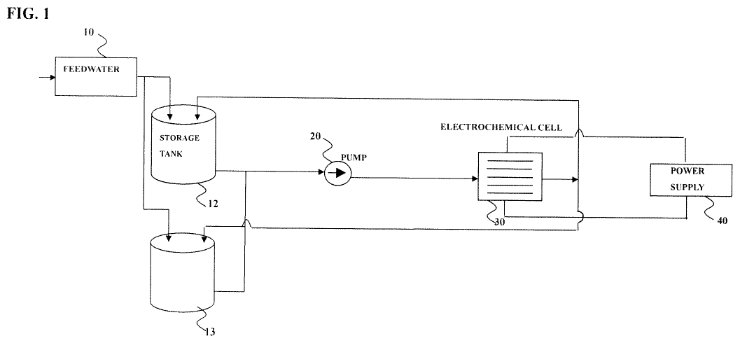

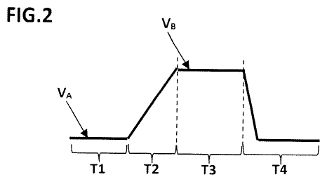

Referring now to the figures, FIG. 1 is a generalized flow schematic which illustrates one use of the inventive method to treat industrial wastewater. The feedwater, an industrial wastewater 10 containing organic compound solutes, is provided in a storage tank 12. The wastewater is routed to the inlet of a pump 20 and then routed to the inlet of an electrochemical cell 30. The electrochemical cell 30 contains at least two electrodes manufactured from boron doped diamond, BDD, arranged such that the wastewater can flow between the electrodes and contact both electrodes. In an embodiment, the electrochemical cell 30 contains several pairs of BDD electrodes arranged to form parallel flow paths through the unit. The water is then returned to the storage tank 12. A power supply 40 is connected to the electrochemical cell 30 and at least one application of direct current is caused to flow through the electrochemical cell 30 in accordance with the power profile shown in FIG. 2. One power cycle is all that is required to initiate an enduring chain reaction in the aqueous solution, although several cycles may be applied in quick succession. The power is then switched off. The application of power creates at least one long half-life free radical which is sustained for several seconds in the pipework as the water flows from the electrochemical cell 30 to the tank 12. Once the water enters the tank 12 the tank 12 can be isolated. The chain reaction then propagates through the tank 12 consuming the available targeted reactants. Once all available reactants are consumed the chain reaction terminates. The chain reaction normally continues for tens of seconds but can continue for several minutes depending on the concentration of the available reactants in the aqueous solution. During this time of propagation and reaction in the isolated tank 12, water from an additional tank 13, or tanks, can be consecutively flowed through the electrochemical cell 30 and at least one cycle of power as shown in FIG. 2 applied so as to initiate the chain reaction in several tanks in quick succession.

FIG. 2 is a representation of the way in which power is applied to the electrochemical cell in one embodiment of the invention. A single complete cycle of the applied power sequence as shown in FIG. 2 is sufficient to initiate the enduring chain reaction. The essential features of the applied power sequence can be described as follows:

Time period T1: a direct current is caused to flow through the electrochemical cell so as to cause a potential difference, V_{A}, to be present across the electrochemical cell.

Time period T2: the current flowing through the electrochemical cell is varied so that the potential difference across the cell is increased to a specific voltage, V_{B}, at which the required at least one long half-life free radical is generated causing the chain reaction to initiate. The rate at which the current is varied is controlled so as to achieve a particular required rate of rise in the potential difference across the electrochemical cell. The value of V_{B} is a specific required value so as to cause the anodic voltage on each pair of electrodes in the electrochemical cell to be in the range of about 2.3V to about 2.9V vs SHE (Standard Hydrogen Electrode).

Time period T3: once V_{B} has been achieved, either the potential difference across the electrochemical cell, or the current flowing through it, is kept constant for a short period. The period can be less than one second or a greater value.

Time period T4: the current is varied so as to decrease the potential difference across the electrochemical cell, normally, but not necessarily, to the initial voltage, V_{A}. The durations of T4 and T1 are not critical and can be less than or more than several seconds.

By controlling the power transient correctly and accurately, then only a single pulse or cycle is sufficient to initiate the chain reaction. To ensure that the required at least one long half-life free radical is generated so as to initiate the desired chain reaction, further power cycles may be applied in quick succession and the polarity also may be reversed. All successive power cycles incorporate in some fashion periods T1 to T4 and, in particular, the parameters of rate of voltage rise and V_{B} identified in T2 above are accurately controlled.

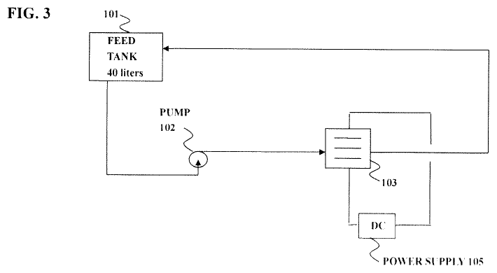

In FIG. 3, a generalized flow schematic illustrates the laboratory setup of the invention which is used to test various waters which are provided to a feed tank 101 as a once-only addition. The water is routed from the feed tank 101 to the inlet of a pump 102 and then to the inlet of the electrochemical cell 103. The electrochemical cell 103 comprises four pairs of boron doped diamond, BDD, electrodes arranged such that the water can flow between the electrodes and contact both electrodes in each pair. A DC power supply 105 is connected to the electrochemical cell 103 and an electric current controlled in accordance with the power profile shown in FIG. 2 is caused to pass through the electrodes and the water. After exiting the electrochemical cell 103, the water is returned to the feed tank 101; entering the feed tank 101 approximately 6 seconds after exiting the electrochemical cell 103. After at least one cycle of the power profile shown in FIG. 2, the power is switched off and the water is circulated through the system to encourage mixing as the chain reaction propagates throughout the feed tank 101. The chain reaction continues for several minutes until it terminates after consuming the available targeted reactants.

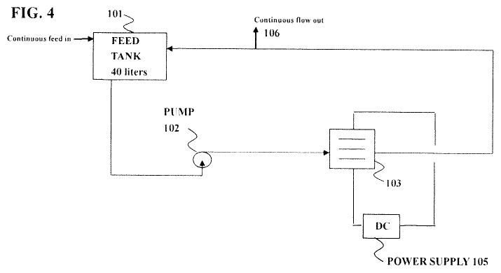

FIG. 4 is another embodiment of the invention illustrating a generalized flow schematic of the laboratory setup which is used to test various waters which are provided to the feed tank 101 continuously. The water is routed from the feed tank to the inlet of a pump 102 and then to the inlet of the electrochemical cell 103 which contains four pairs of boron doped diamond, BDD, electrodes arranged such that the water can flow between the electrodes and contact both electrodes in each pair. A DC power supply 105 is connected to the electrochemical cell 103 and an electric current controlled in accordance with the power profile shown in FIG. 2 is caused to pass through the electrodes and the water. After exiting the electrochemical cell 103, a proportion of the circulating water flows out of circulation 106 while the remainer of the circulating water is returned to the feed tank 101 approximately 6 seconds after exiting the electrochemical cell 103. After at least one cycle of the power profile shown in FIG. 2, the power is switched off and the water is circulated through the system to encourage mixing as the chain reaction propagates throughout the feed tank 101. The chain reaction continues for several minutes until it terminates after consuming the available targeted reactants.

By means of extensive studies and experiments, the inventors have developed a means of creating a long half-life free radical-initiated chain reaction in aqueous solution. Importantly, the inventors have confirmed that such a chain reaction can be propagated and sustained such that targeted contaminants in water can be removed from the system. This is a unique method for the treatment of water so as to remove contamination from the environment at very low cost, low temperature, and low pressure which has not been demonstrated by the prior art.

The method described herein can be practiced in many industrial and municipal applications. For many important applications, feedwater may contain a mixture of organic solutes. The relative concentration of each of the different solutes is uncontrolled and the total dissolved organic concentration can be variable. The organic solutes can be removed to any desired final concentration.

In other applications, feedwater may contain PFAS, per- and polyfluoroalkyl substances. The inventive method is able to remove or destroy PFAS so as to reduce total PFAS concentration from any initial value to low ppt, parts per trillion, concentration.

In another application of the inventive method, feedwater may contain perchlorate. The inventive method is able to remove or destroy perchlorate to low concentrations.

In another application of the invention method, feedwater may contain a mixture of ammoniacal nitrogen, organic phosphates, nitrates, and inorganic phosphates. All of the aforementioned solutes are effectively removed or destroyed by the method of the invention.

In other applications of the inventive method, feedwater may contain solutes which are effective bactericides, such as compounds containing the CN group or active pharmaceutical agents. All such solutes are removed or destroyed by the method of the invention.

In another application, the inventive method may be used to produce at least one long half-life free radical which is able to initiate chain reactions which result in the synthesis of organic chemicals.

Thus, the inventive features of the method disclosed herein are: (1) an enduring chain reaction initiated in a small volume of water by a single pulsed application of power; (2) once initiated, the chain reaction is sustained as it transfers into a larger volume of water; (3) once entering the larger volume of water, the chain reaction propagates and continues without outside influence until all available reactants are consumed, at which point it terminates; (4) The method is very low cost; (5) chain reactions can be initiated and propagated in several water volumes using a single electrochemical cell such that the several chain reactions continue at the same time.

### EXAMPLES

The present invention is more particularly described in the following non-limiting examples, which are intended to be illustrative only, as numerous modifications and variations therein will be apparent to those skilled in the art.

### Example 1

In one test, as shown in FIG. 3, an 8 liter volume of an aqueous solution containing 3,334 ppm of sulfide anion was placed in the tank. The wastewater was circulated through the electrochemical cell at a flowrate of 7 liters per minute. The power applied to the electrochemical cell had the profile as shown in FIG. 2 and a total of three cycles were applied in succession. Total energy consumed was less than 100 joules. The sulfide concentration in the water was reduced to less than 300 ppm. The reaction took approximately 5 minutes to complete and terminate.

### Example 2

In a second test, a 20 liter volume of an aqueous solution containing 3,334 ppm of sulfide anion and 2,150 ppm of phenol was placed in the tank. The water was circulated through the electrochemical cell at a flowrate of approximately 7 liters per minute. The power applied to the electrochemical cell had the profile as shown in FIG. 2 and a total of four cycles were applied in succession. Total energy consumed was less than 120 joules. The sulfide concentration was reduced to less than 300 ppm and the phenol concentration reduced to less than 250 ppm. The reaction took approximately five minutes to complete and terminate.

### Example 3

In a third test, an 8 liter volume of an aqueous solution containing 4,000 ppm of bicarbonate/carbonate anion was placed in the tank. The water was circulated through the electrochemical cell at a flowrate of approximately 7 liters per minute. The power applied had the profile as shown in FIG. 2 and a total of three power cycles were applied in succession. Total energy consumed was less than 150 joules. The carbon dioxide/bicarbonate/carbonate concentration was reduced to less than 2,000 ppm. The reaction took approximately five minutes to complete and terminate. The exemplary results of such testing, and in particular the low amount of energy required, the short duration of its application, and the long time the chain reaction continued removing the contaminants present in aqueous solution with no further power applied demonstrated the extraordinary efficacy of the unique method of the invention.

### Example 4

A fourth test entails placing an 8 liter volume of an aqueous solution containing 1000 ppm of acetic acid in the tank. The water is circulated through the cell at a flowrate of approximately 7 liters per minute. An aqueous solution containing 1000 ppm of acetic acid is continuously fed into the feed tank at a rate of 2 liters per minute. There is a continuous flow out of the system at 2 liters per minute. The power is applied with the profile as shown in FIG. 2 for several cycles. The acetic acid concentration in the water flowing out of the system is reduced to less than 160 ppm, continuously.

It will thus be seen that the objectives set forth above including those made apparent from the foregoing description, are effectively and efficiently attained, and as certain changes may be made in carrying out the above method and in construction of a suitable apparatus in which to practice the method and in which to produce the desired product as set forth herein, it is to be understood that the invention may be embodied in other specific forms without departing from the spirit or essential characteristics thereof. For example, while we have set forth an exemplary design for the treatment of aqueous solutions by a long half-life free radical-initiated chain reaction, other embodiments are also feasible to attain the result of the principles of the method disclosed herein. Therefore, it will be understood that the foregoing description of representative embodiments of the invention have been presented only for the purposes of illustration and for providing an understanding of the invention, and it is not intended to be exhaustive or restrictive, or to limit the invention to the precise forms disclosed. On the contrary, the intention is to cover all modifications, equivalents, and alternatives falling within the spirit and scope of the invention as expressed in the appended claims. As such, the claims are intended to cover the methods and structures described herein, and not only the equivalents or structural equivalents thereof, but also equivalent structures or methods. Thus, the scope of the invention, as indicated by the appended claims, is intended to include variations from the embodiments provided which are nevertheless described by the broad meaning and range properly afforded to the language of the claims, or the equivalents thereof.

What is claimed is:

1. A method for the initiation and propagation of an enduring chain reaction in an aqueous solution in an electrochemical apparatus, said electrochemical apparatus comprising at least one electrochemical cell containing boron doped diamond (BDD) electrodes to produce water with low concentrations of particular solutes, said method comprising:
(a) providing a feedwater stream to a feed tank, said feedwater stream comprising an aqueous solution containing solutes therein, said solutes comprising organic species or molecules, ammoniacal nitrogen, organic nitrogen, inorganic phosphates, organic phosphates, inorganic sulfides, organic sulfides, nitrates, per-and polyfluoroalkyl substances, carbon dioxide, bicarbonates, carbonates and combinations thereof;
(b) passing the feedwater from step (a) through said electrochemical cell such that the water contacts the BDD electrodes contained therein;
(c) causing a direct electrical current to flow through the electrochemical cell so as to create at least one long half-life free radical which initiates an enduring chain reaction in the aqueous solution, said direct current varied and controlled to apply a specific power scheme to the electrochemical cell which includes at least one cycle, or pulse, wherein the potential difference applied across the cell is raised to a specific value at a precise, controlled rate of voltage increase and once the specific value of voltage is achieved the voltage is decreased;
(d) allowing the aqueous solution to flow into a larger volume of water containing some or all of the solutes described in step (a) such that the enduring chain reaction propagates throughout the larger volume without needing further energy input to the electrochemical cell and without outside influence, and progresses until the chain reaction has reduced or destroyed all available reactants, at which time the chain reaction terminates.

2. The method according to claim 1, wherein on completion of step (d), steps (a) to (d) are repeated one or more times so that the enduring chain reaction is initiated and propagated in one or more separate additional water volumes.

3. The method according to claim 1, wherein at step (c) the direct current is varied so as to cause the potential difference across the electrochemical cell to be raised so as to achieve a specific value of anodic potential in each electrode pair in the electrochemical cell which is within the range of 2.50V to 2.85V versus SHE, standard hydrogen electrode, in an elapsed time period of one second or less.

4. The method according to claim 1, wherein at step (c) the direct current is varied so as to cause the potential difference across the electrochemical cell to be raised so as to achieve a specific value of anodic potential in each electrode pair in the electrochemical cell which is within the range of 2.50V to 2.85V versus SHE, standard hydrogen electrode, in an elapsed time period of half a second or less.

5. The method as set forth in claim 1 wherein at step c) the direct current is varied so as to cause the potential difference across the electrochemical cell to be raised so as to achieve a specific value of anodic potential in each electrode pair in the electrochemical cell which is within the range 2.50V to 2.85V versus SHE, standard hydrogen electrode, in an elapsed time period of a third of a second or less.

6. The method as set forth in claim 1 wherein at step (d) the chain reaction is allowed to propagate to cause the synthesis of different organic chemical or polymers as a desired product.

7. The method according to claim 1, wherein the chain reaction propagation time ranges from several seconds to several minutes depending on the concentration of the available reactants in the aqueous solution.

8. The method according to claim 1, wherein the chain reaction is initiated when a single cycle, or pulse, is applied to the electrochemical cell by the varied and controlled direct current.

9. The method according to claim 1, wherein the feedwater stream is provided to the feed tank as a once-only addition.

10. The method according to claim 1, wherein the feedwater stream is provided to the feed tank continuously.
